(19) United States
(12) Patent Application Publication
(10) Pub. No.: US 2007/0240539 A1
(43) Pub. Date: Oct. 18, 2007

(54) Article for Increasing Titanium Content of Steel

(76) Inventor: David John Ingall, Sheffield (GB)

Correspondence Address: JAMES C. WRAY, 1493 CHAIN BRIDGE ROAD, SUITE 300, MCLEAN, VA, 22101, US

(21) Appl. No.: 11/632,514

(22) PCT Filed: Jul. 7, 2005
(86) PCT No.: PCT/GB05/02690

§ 371 Date: Jan. 16, 2007

(30) Foreign Application Priority Data
Jul. 16, 2004 (GB) 0415940.6

(51) Int. Cl. C22C 1/02; B22F 1/00; B22F 5/12; B23K 35/00

(52) U.S. Cl. 75/330; 419/61; 419/62; 428/576

(57) ABSTRACT

An article (101) for insertion into molten steel (102) to increase titanium content of the steel. The article comprises a container (201) formed from a metal or metal alloy, and a mixture (202) enclosed within the container. The mixture comprises: iron in the form of an oxide; titanium in the form of an oxide; and aluminium or aluminium alloy. The mixture is such that when heated it reacts to oxidise the aluminium and produce ferro-titanium alloy.

### BACKGROUND OF THE INVENTION

The present invention relates to an article for insertion into molten steel to increase titanium content of the steel, a method of manufacturing an article for insertion into molten steel to increase titanium content, and a method of increasing the titanium content of molten steel.

It is known in the manufacture of steel to increase the titanium content of the steel by adding ferro-titanium alloy to the molten steel. This is typically done by adding lumps of ferro-titanium and then using ferro-titanium cored wire to make fine adjustments. Whereas titanium metal has a higher melting temperature than those used in steel production, the ferro-titanium has a lower temperature and readily alloys with the steel.

A problem with such a process is that the added ferro-titanium absorbs heat to bring it up to the temperature of the steel and to melt it. Consequently, this heat must be added to the ladle to maintain its temperature.

A second problem with this process is that the production of ferro-titanium is itself costly in terms of energy, plant and man-power.

### BRIEF SUMMARY OF THE INVENTION

According to a first aspect of the present invention, there is provided an article for insertion into molten steel to increase titanium content of the steel, said article comprising a container formed from a metal or metal alloy, and a mixture enclosed within the container, wherein said mixture comprises: iron in the form of an oxide; titanium in the form of an oxide; and aluminium or aluminium alloy, such that when heated said mixture reacts to oxidise the aluminium and produce ferro-titanium alloy.

According to a second aspect of the present invention, there is provided a method of manufacturing an article for insertion into molten steel to increase titanium content of the steel, comprising the steps of (a) obtaining in particulate form: iron in the form of an oxide; titanium in the form of an oxide; and aluminium or aluminium alloy, (b) mixing said aluminium with said titanium and iron to produce a mixture; (c) locating said mixture within a metal or metal alloy container to produce said article.

According to a third aspect of the present invention, there is provided a method of increasing the titanium content of molten steel comprising the step of lowering cored wire into molten steel to initiate a reaction between constituents of a mixture contained in said cored wire, wherein said cored wire contains a mixture of: (i) aluminium or aluminium alloy; (ii) a compound comprising an oxide of iron and titanium; and (iii) titanium or titanium alloy.

### BRIEF DESCRIPTION OF THE SEVERAL VIEWS OF THE DRAWINGS

FIG. 1 illustrates the use of cored wire 101 embodying the present invention;

FIG. 2 shows a short length of cored wire 101;

FIG. 3 shows a flow chart illustrating the main steps in producing an article, such as the cored wire 101;

FIG. 4 shows further detail of the step 302 of processing raw material to produce the required form for mixing;

FIG. 5 shows an illustration of a ball mill 501 adapted for reducing the particle size of titanium at step 404;

FIGS. 6A, 6B and 6C shows aluminothermic reactions which are made use of in some embodiments of the invention;

FIGS. 7A to 7E show tables of different examples of mixtures used in the cored wire 101; and

FIGS. 8A and 8B show tables of mixtures using alternative types of components.

### WRITTEN DESCRIPTION OF THE BEST MODE FOR CARRYING OUT THE INVENTION

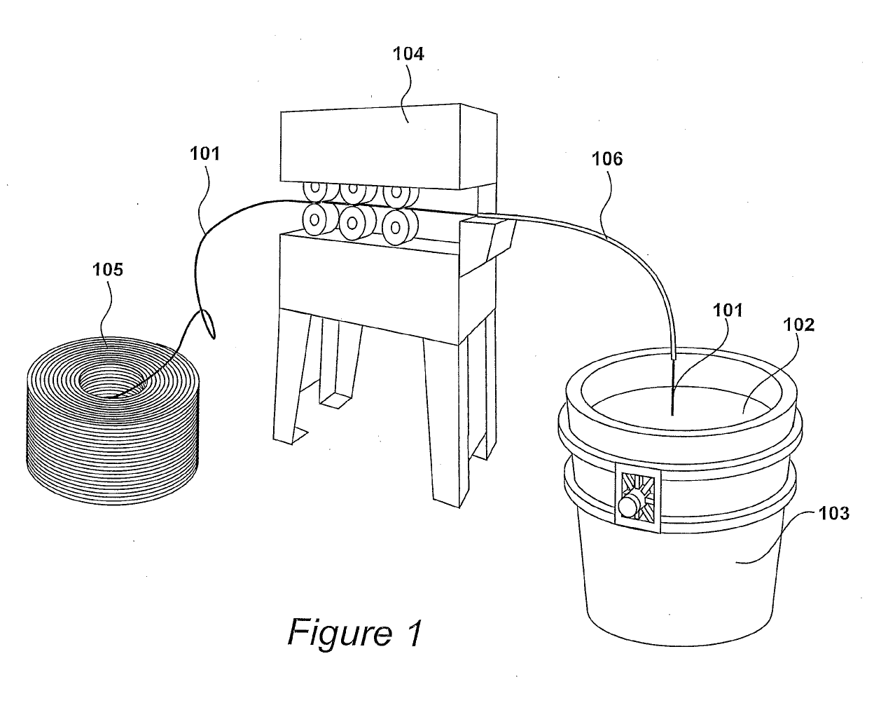

FIG. 1

The use of cored wire 101 embodying the present invention is illustrated in FIG. 1. Following the production of steel in a furnace, such as a basic oxygen furnace (not shown), molten steel 102 is transferred to a ladle 103 for transportation to a casting facility. In order to adjust the metallurgy of the molten steel 102 various components are added while it is in the ladle.

These components include metals and/or metal alloys which dissolve into the steel and thereby adjust its alloy composition.

In the present example, the titanium content of the steel 102 is increased by injecting cored wire 101 into it. A wire injector 104 draws the cored wire 101 from a coil 105 of wire supported within a cage (not shown), feeds it through a guide tube 106 and lowers it into the molten steel 102. The cored wire 101 has a core comprising a mixture of reactive components which are heated by the steel to initiate a reaction between said components. One product of the reaction is ferro-titanium, an alloy of iron and titanium. The produced ferro-titanium has a melting point below that of the molten steel and therefore the molten alloys mix to increase the titanium content of the steel 102.

Generally, materials inserted into the molten steel absorb a proportion of its heat, and consequently it is known to have means for re-heating the steel in the ladle to maintain its temperature. However, the reaction which occurs between the constituents of the mixture within the cored wire 101 is exothermic, and therefore, once the reaction is initiated, the cored wire provides some heat back to the steel.

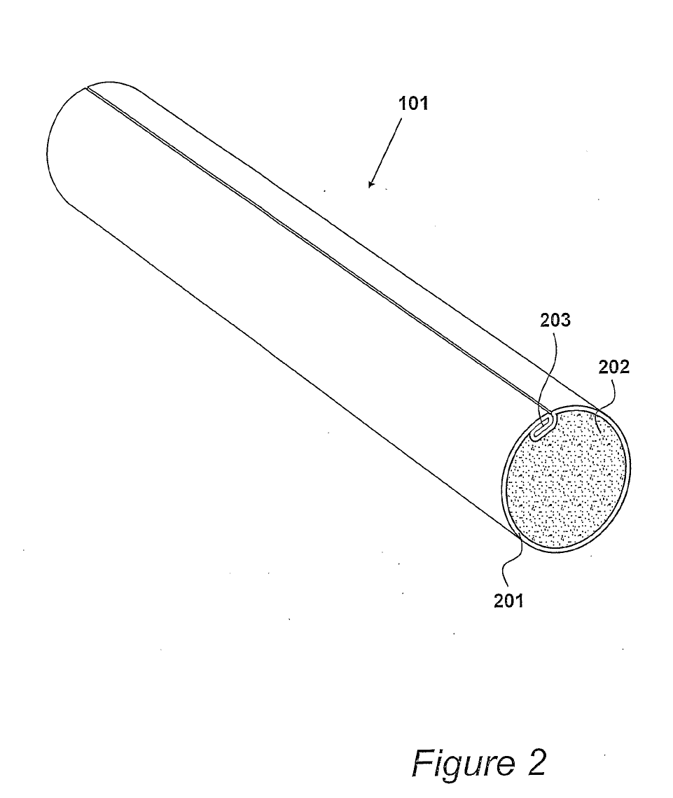

FIG. 2

A short length of cored wire 101 is shown in FIG. 2. The core wire 101 has a uniform structure along its length comprising of: a container 201, in the form of metal or metal alloy tube; and a core 202.

The tube is formed from metal strip which is rolled into a tubular form with opposing edges folded together to form a seam 203.

In the present instance the metal tube is made from mild steel but, depending upon the type and quality of the steel being produced in ladle 103, other metals or alloys may be used. In one alternative embodiment, the tube is made from aluminium and is used to reduce oxygen content of the steel at the same time as the ferro-titanium is added.

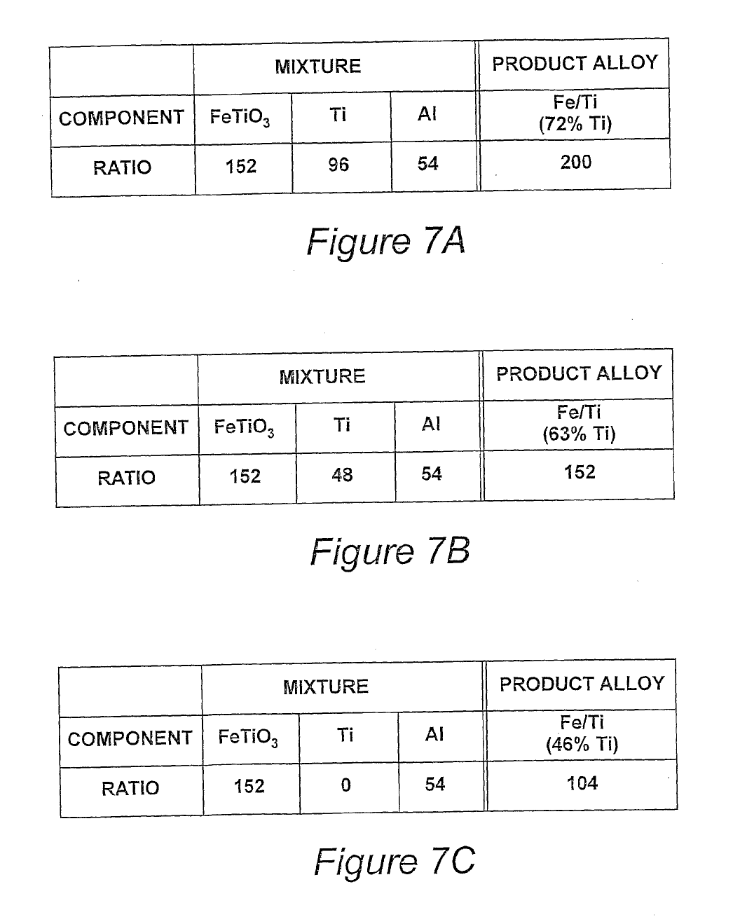

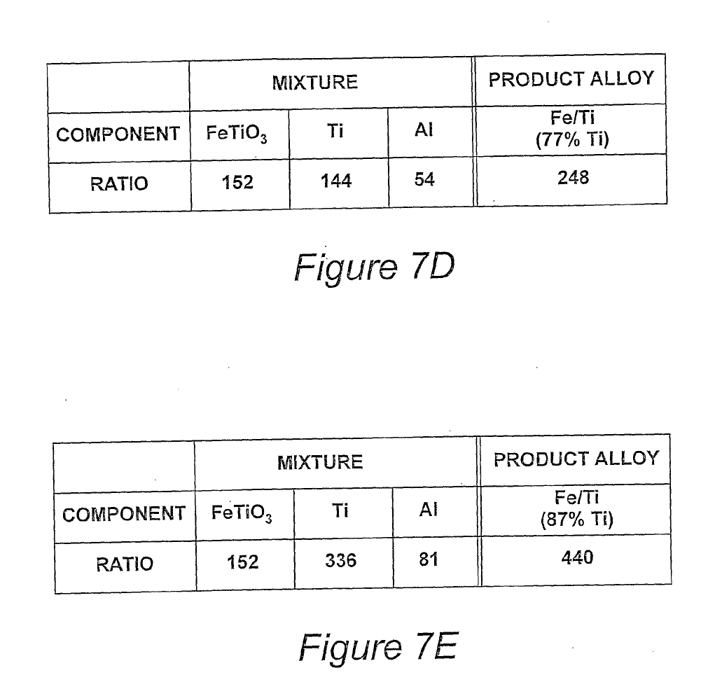

The core 202 is a mixture of materials in the form of small particles having dimensions of three millimetres or less. The mixture comprises: iron in the form of an oxide; titanium in the form of an oxide; titanium or titanium alloy; and aluminium or aluminium alloy, such that when heated the mixture exothermically reacts to oxidise the aluminium and produce ferrotitanium. i.e. the iron/titanium oxides are reduced by an aluminothermic reaction. The particular mix of materials in the core will be described below in detail with respect to FIGS. 7A to 7G.

The container 201 has several functions. Firstly, the container provides the cored wire with the mechanical strength necessary for it to be handled and forced down into the molten steel 102 below any slag which may be present at the surface of the steel.

Secondly, the container provides a barrier between the molten steel 102 and the core 202 while the reaction between components of the core takes place. This is important because otherwise the constituents of the core mixture could disperse within the molten steel before they have completely reacted. The main consequence would be that at least a portion of the titanium would fail to become part of the molten steel alloy.

Thirdly, the container 201 is configured to dissolve into the molten steel 102 to release the products of the reaction from its core.

When the reaction between components of the core is initiated, the temperature of the core 202 may become higher than that of the molten steel 102 due to the exothermal nature of the reaction. The core 202 consequently expands to produce a pressure on the inside wall of the tube 201, and, for this reason, the material and wall-thickness of tube are chosen to provide sufficient strength to maintain its integrity while the reaction takes place.

In cases where the particle sizes of the core are relatively small the reaction time decreases and the core temperature will become relatively high. Where particle sizes are relatively large (between two and three millimetres) the reaction time is increased and core temperature will be lower. In addition, the core temperature and pressure vary with the diameter of the tube, which is typically between ten and thirty millimetres. Thus, when choosing the tube material and wall-thickness, the diameter of the tube and particle sizes of the core mixture are considered.

In the present embodiment the tube 201 has a circular cross-section, but in other embodiments the cross-section is polygonal, such as square.

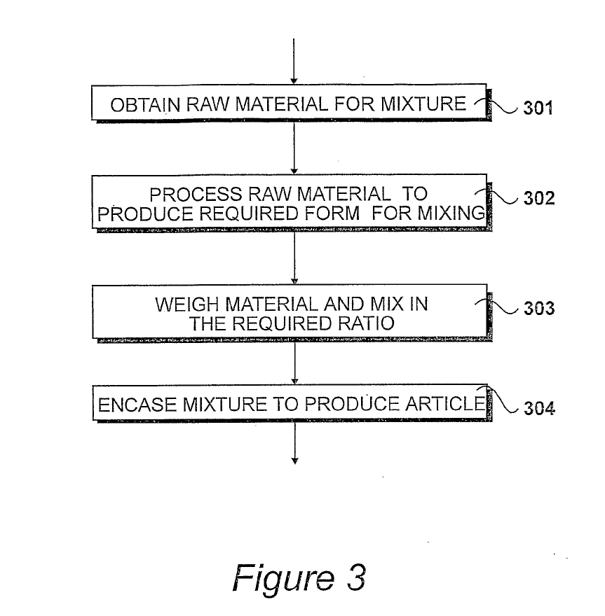

FIG. 3

A flow chart illustrating the main steps in producing an article, such as the cored wire 101, is shown in FIG. 3. Initially, at step 301, raw material for the core mixture is obtained. In some embodiments, the mixture comprises ilmenite, a mineral comprising an oxide of iron and titanium with the chemical formula FeTiO₃, scrap titanium or titanium alloy, and aluminium or aluminium alloy.

Ilmenite is mined in countries such as South Africa and Australia and may be obtained through agents such as Raw Material Solutions Limited, UK. The aluminium may be obtained in granular form from one of many manufacturers/suppliers, such as Mountstar Metal Corporation Limited, UK.

Following step 301, the raw materials are processed at step 302 to present them in a form that is required for the core mixture. Specifically, the particle size is reduced if necessary, and the metals are degreased where necessary.

At step 303 the component raw materials are weighed and mixed in the required ratio. The mixture produced at step 303 is then encased at step 304 to produce an article for subsequent insertion into molten steel to increase the titanium content. Thus, for example, at step 304 a metal tube is formed in a rolling mill and said tube is filled with the mixture to produce the cored wire 101.

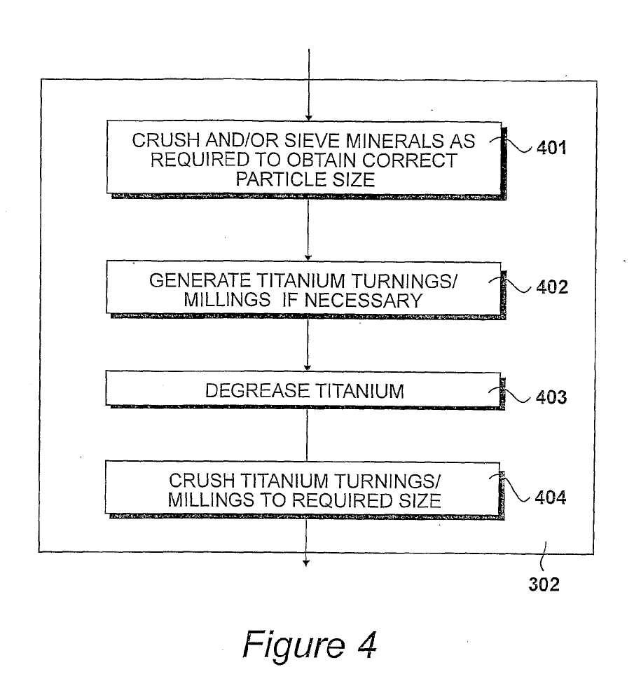

FIG. 4

The step 302, of processing raw material to produce the form required for mixing, is shown in further detail in FIG. 4.

If required, minerals, such as ilmenite, are sieved at step 401 to obtain the required particle sizes for use in the core mixture. If necessary, larger particles are crushed, for example in a ball mill, before being sieved to select the required range of particle sizes.

Where the titanium obtained at step 301 comprises large objects, the titanium is machined at step 402 to produce turnings and/or millings. The titanium is then degreased at step 403. This degreasing step may take the form of a washing process using, for example, organic solvents, or a baking process in which the titanium turnings are baked in air to evaporate and/or burn-off organic contaminants.

Degreased titanium turnings/millings are then crushed down to the required size at step 404.

Aluminium is readily available for purchase in various granule sizes, including those required for the present invention. Consequently, no further processing of the aluminium may be necessary at step 302. However, if it is necessary, the aluminium may be ground down to required particle size, for example in a ball mill.

It will be understood that the processing of the ilmenite and titanium are independent of each other, and step 401 may be performed at the same time or after steps 402 to 404.

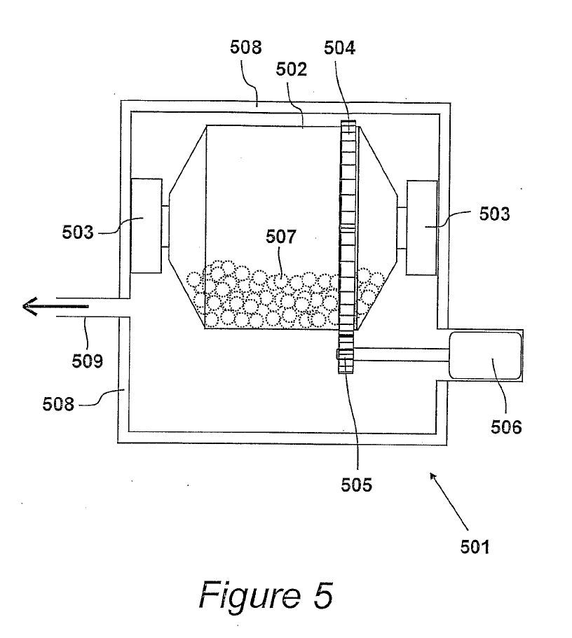

FIG. 5

A ball mill 501 adapted for reducing the particle size of titanium at step 404 is illustrated in FIG. 5. The ball mill 501 comprises a cylinder 502 supported at each end by bearings 503 allowing the cylinder to rotate about its central axis. On its outer surface, the cylinder 502 supports a slave gear 504 which is configured to be driven by a drive gear 505; the drive gear is itself configured to be driven by an electric motor 506.

The cylinder 502 contains steel balls 507 and, during use, titanium turnings that are to be crushed down to correct size. In operation, the cylinder 502 is rotated by the motor 506 via the gears 505 and 504. This action causes the balls 507 to tumble, thereby crushing and grinding the titanium turnings.

Unlike conventional ball mills, air is removed from the cylinder during operation of the ball mill to avoid sparks causing combustion of the titanium. For this reason, the cylinder is located within a vacuum chamber 508 having a pipe 509 by which it is evacuated of air. The cylinder 502 is itself provided with vents (not shown) such that air may be removed from the cylinder.

The vacuum chamber is provided with vacuum tight doors (not shown) such that access is provided to load and unload batches of titanium from the ball mill.

In an alternative embodiment, the chamber 508 is provided with a gas outlet and a gas inlet connected to a supply of inert gas, such as argon. During operation, air is driven from the chamber by flushing it with inert gas and then maintaining an atmosphere of inert gas above atmospheric pressure.

In an alternative example, a roll mill is used in place of a ball mill, but in either case the apparatus is evacuated of air to avoid combustion of the titanium.

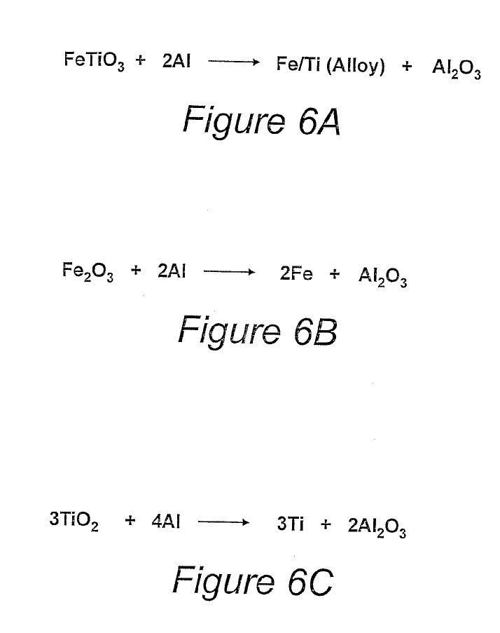

FIGS. 6A, 6B and 6C

Aluminothermic reactions which are made use of in some embodiments of the invention are shown in FIGS. 6A, 6B and 6C. In some embodiments, the core mixture 202 comprises ilmenite and aluminium particles which react as shown in FIG. 6A to produce ferro-titanium alloy and aluminium oxide. The ferro-titanium alloys with the molten steel while the aluminium oxide floats to the surface of the molten steel to form slag.

In other embodiments, the mixture includes iron oxide, Fe₂O₃, and aluminium which react as shown in FIG. 6B to form iron and aluminium oxide, while titanium oxide, TiO₂, contained within the mixture reacts with the aluminium as shown in FIG. 6C to form titanium and aluminium oxide. The iron and titanium of the reactions of FIGS. 6B and 6C mix to form ferro-titanium alloy.

FIG. 7A to 7E

A number of different examples of mixtures used in the cored wire 101 are shown in the tables of FIGS. 7A, 7B, 7C, 7D and 7E.

The mixture shown in the table of FIG. 7A comprises ilmenite, titanium metal and aluminium metal with masses in the ratio 152 to 96 to 54 respectively. The ilmenite (FeTiO₃) is reduced by the aluminium as shown in FIG. 6A. The titanium is dissolved into the product during the reaction and thereby the titanium content of the product alloy is increased to 72%. Therefore, in this example, the product alloy has a titanium to iron ratio that is close to that of the eutectic alloy. Consequently, due to its low melting temperature, it will readily dissolve into molten steel during steel production.

The mixture shown in the table of FIG. 7B is similar to that of FIG. 7A, but the titanium metal content has been halved. Consequently, the titanium content of the product alloy is reduced to 63%.

Because the mixture of FIG. 7B contains a higher proportion of the less expensive ilmenite and less of the relatively expensive titanium metal, the cost of production of the cored wire is reduced. Consequently, despite the need to add more cored wire for a given increase of titanium to the molten steel 102, use of cored wire using the mixture of FIG. 7B is less expensive than that of FIG. 7A.

As indicated above, the ratio of ilmenite to titanium metal may be increased to reduce the overall cost of the titanium added to the molten steel. FIG. 7C provides an extreme case in which no titanium metal is included in the mixture. Thus, the mixture of FIG. 7C merely comprises of ilmenite and aluminium, and the resulting product alloy only has a 46% titanium content.

A mixture of high titanium content is shown in FIG. 7D. Thus, the mixture contains ilmenite, titanium metal and aluminium with masses in the ratio 152 to 144 to 54, and the resulting alloy has a 77% titanium content.

A mixture having an even higher titanium content is shown in FIG. 7E. Thus, the mixture contains ilmenite, titanium metal and aluminium with masses in the ratio 152 to 336 to 81, and the resulting alloy has a 87% titanium content.

During addition of the core wire 101 to the molten steel 101, other elements are added to the steel that are not desired, such as oxygen and nitrogen. Although more expensive, the cored wire with the mixture of FIGS. 7D and 7E add less of these undesirable elements, since less cored wire is required. However, due to the smaller proportion of the reacting materials in the mixture of FIG. 7E, the time required for total reaction may be prohibitive in some applications.

The ratio of ilmenite to titanium that is used will depend upon the type of steel 101 being produced and characteristics of the foundry. Where low cost is required for a lower grade steel, a low titanium content mixture may be used, and where higher grade steel is required a higher titanium content mixture may be required. However, a core mixture that produces a low melting point ferro-titanium alloy, with titanium content between 60% and 80%, and preferably between 68 and 72%, may be most tolerant of variations in cored wire insertion speeds.

The ratios of components in the mixtures of FIGS. 7A to 7E are provided as examples and other ratios are envisaged.

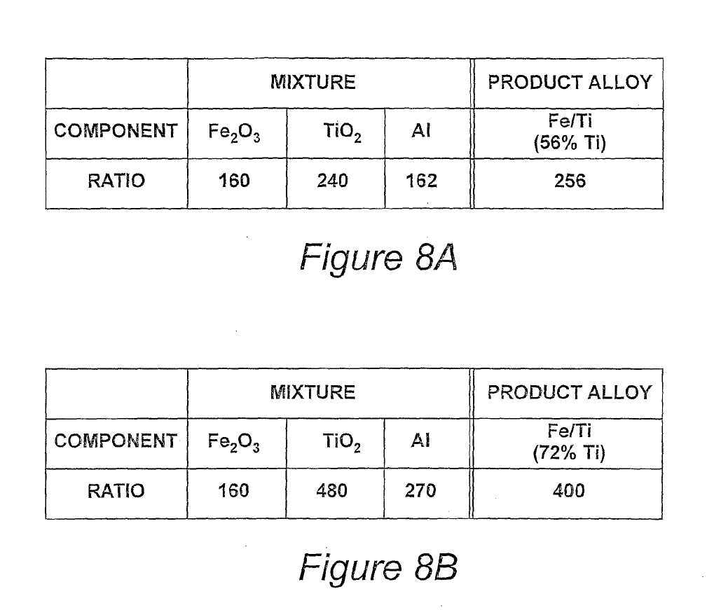

FIGS. 8A and 8B

Mixtures using alternative types of components are shown in FIGS. 8A and 8B. In each case, the mixture comprises: iron oxide, Fe₂O₃; titanium oxide, TiO₂; and aluminium. The ratio of masses of these components in the mixture of FIG. 8A is 160 to 240 to 162, and a ferro-titanium alloy comprising 56% titanium is produced. The corresponding ratio in FIG. 8B is 160 to 480 to 270, with an alloy having 72% titanium being produced.

During use, the components of the mixtures react in the manner indicated in FIGS. 6B and 6C.

Unlike the mixtures of FIG. 7A to 7E, the mixtures of FIGS. 8A and 8B do not make use of the relatively inexpensive ilmenite, but do not require the relatively costly titanium metal.

1. An article for insertion into molten steel to increase titanium content of the steel, said article comprising
a container formed from a metal or metal alloy, and
a mixture enclosed within the container,
wherein said mixture comprises:
iron in the form of an oxide;
titanium in the form of an oxide; and
aluminium or aluminium alloy,
such that when heated said mixture reacts to oxidise the aluminium and produce ferro-titanium alloy.

2. An article according to claim 1, wherein said mixture includes a single compound containing said titanium and iron.

3. An article according to claim 1, wherein said titanium in the form of an oxide is iron titanium oxide.

4. An article according to claim 1, wherein said mixture comprises titanium oxide.

5. An article according to claim 1, wherein said mixture comprises titanium metal or titanium alloy.

6. An article according to claim 1, wherein said mixture comprises titanium metal or titanium alloy such that the titanium content of the ferrotitanium is between 60% and 80%.

7. An article according to claim 1, wherein said mixture comprises titanium metal or titanium alloy such that the titanium content of the ferrotitanium is between 68% and 72%.

8. An article according to claim 1, wherein said container is an open ended tube, and said article is cored wire.

9. An article according to claim 1, wherein said container is formed from iron or steel.

10. An article according to claim 1, wherein said container is formed from aluminium or aluminium alloy.

11. An article according to claim 1, wherein said mixture comprises particles of iron-titanium oxide, particles of aluminium or aluminium alloy and particles of titanium or titanium alloy.

12. An article according to claim 11, wherein said particles each have a maximum dimension of three millimetres or less.

13. A method of producing an article for insertion into molten steel to increase titanium content of the steel, comprising the steps of
(a) obtaining in particulate form:
iron in the form of an oxide;
titanium in the form of an oxide; and
aluminium or aluminium alloy,
(b) mixing said aluminium with said titanium and iron to produce a mixture;
(c) locating said mixture within a metal or metal alloy container to produce said article.

14. A method according to claim 13, wherein said mixture includes a single compound containing said titanium and iron.

15. A method according to claim 13, wherein said titanium in the form of an oxide is iron titanium oxide.

16. A method according to claim 13, wherein said mixture comprises titanium oxide.

17. A method according to claim 13, wherein said method further comprises mixing titanium metal or titanium alloy in particulate form into said mixture.

18. A method according to claim 17, wherein said method comprises a degreasing process in which the titanium metal or titanium alloy is baked.

19. A method according to claim 17, wherein said method comprises a crushing process in which particles of titanium or titanium alloy or crushed in a mill to produce smaller particles.

20. A method according to claim 19, wherein said titanium or titanium alloy is crushed in a chamber that is evacuated of air to avoid combustion of the titanium.

21. A method according to claim 17, wherein sufficient titanium metal or titanium alloy is added to the mixture such that when said mixture reacts to form ferro-titanium the titanium content of the ferro-titanium is between 60% and 80%.

22. A method according to claim 17, wherein sufficient titanium metal or titanium alloy is added to the mixture such that when said mixture reacts to form ferro-titanium the titanium content of the ferro-titanium is between 68% and 72%.

23. A method according to claim 17, wherein said step (a) comprises obtaining in particulate form:
iron-titanium oxide;
titanium or titanium alloy; and
aluminium or aluminium alloy.

24. A method according to claim 23, wherein each particle has a maximum dimension of three millimetres or less.

25. A method according to claim 13, wherein said container is an open ended tube, and said tube is filled with said mixture to produce cored wire.

26. A method according to claim 13, wherein said container is formed from iron or steel.

27. A method according to claim 13, wherein said container is formed from aluminium or aluminium alloy.

28. A method of increasing the titanium content of molten steel comprising the step of
lowering cored wire into molten steel to initiate a reaction between constituents of a mixture contained in said cored wire, wherein said cored wire contains a mixture of:
(i) aluminium or aluminium alloy;
(ii) a compound comprising an oxide of iron and titanium; and
(iii) titanium or titanium alloy.
